(19) United States
(12) Patent Application Publication
(10) Pub. No.: US 2016/0282558 A1
(43) Pub. Date: Sep. 29, 2016

(54) OPTICAL HIGHER-ORDER MODE FRUSTRATION IN A RIB WAVEGUIDE

(71) Applicant: Intel Corporation, Santa Clara, CA (US)

(72) Inventors: David N. Hutchison, Santa Clara, CA (US); Jonathan K. Doylend, Morgan Hill, CA (US)

(21) Appl. No.: 14/670,414

(22) Filed: Mar. 27, 2015

(51) Int. Cl. G02B 6/14; G02B 6/136; G02B 6/30; G02B 6/12; G02B 6/122

(52) U.S. Cl. CPC G02B 6/14; G02B 6/12002; G02B 6/122; G02B 6/30; G02B 6/136; G02B 2006/12097

(57) ABSTRACT

A slab of a rib waveguide includes geometric disruption features along a direction of propagation of the waveguide. The geometric disruption features scatter optical modes other than the fundamental mode in the slab without significantly impacting the fundamental optical mode that propagates primarily in the rib waveguide. The rib waveguide has a width to constrain the fundamental mode, and the fundamental mode primarily propagates through the rib waveguide, with some of the energy propagated via the slab. When the slab includes edges that are wider than the rib waveguide and smaller than the substrate on which the rib waveguide and slab are integrated, the slab can propagate optical modes other than the fundamental mode, such as higher-order modes. The geometric disruptions scatter the non-fundamental optical modes from the slab. The geometric disruptions can include serration features in one or both edges of the slab.

### FIELD

Embodiments of the invention are generally related to optical systems, and more particularly to mode frustration in a rib waveguide.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2015, Intel Corporation, All Rights Reserved.

### BACKGROUND

Optical communication offers benefits of high speed and bandwidth. Recent advances have provided techniques to integrate optical transmission structures directly onto an integrated circuit (I/C) die during the I/C processing. Integrating optical transmission paths can be accomplished by creating a waveguide directly in the semiconductor substrate of the I/C. Such a waveguide can be created as a rib waveguide or ridge waveguide, where a rib of semiconductor material is created to constrain transmission of optical signal energy in a direction of propagation.

FIG. 1A illustrates a prior art rib waveguide design. Rib 110 and slab 120 are integrated on substrate 130. In one embodiment, substrate 130 can be, for example, a silicon dioxide (SiO₂) buried layer in a silicon substrate. Rib 110 and slab 120 can be created on substrate 130 via etching techniques. One process creates a full etch to substrate 130, and a partial etch of slab 120 to leave rib 110. In one example, a rib waveguide can include rib width 112 of approximately 400 nm, rib height 114 of approximately 400 nm, slab height 124 of approximately 200 nm, slab width 122 of approximately 25 um (25 microns). It will be understood that certain features of optical circuit 102 of FIG. 1A are not necessarily to scale. Rib height 114 and width 112 generally constrain the optical signal energy that makes up the fundamental mode, and causes the signal to travel in the direction of propagation 140. It will be understood that circuit 102 illustrates a cut-away portion of a waveguide, and could extend further along the direction of propagation 140. Thus, length 116 is not necessarily limited to what is shown. Regardless of actual length, length 116 is at least an order of magnitude longer than the height of the waveguide, and is typically multiple orders of magnitude longer. A full etch of slab 120 to expose substrate 130 is not used in all cases, but such an edge is typically desirable to avoid crosstalk between waveguides.

FIG. 1B illustrates a wave pattern of a fundamental mode for the prior art rib waveguide design of FIG. 1A. Cross-section 104 illustrates a contour map of fundamental TE (transverse electric) mode 150. More specifically, the contour mapping illustrates a simulation of |E|² for a rib waveguide fundamental TE mode that might propagate in circuit 102. The energy dissipates as the circumferences on the contour map get larger. Thus, the majority of the energy for the fundamental mode is constrained in the rib and slab.

As is understood, TE modes have a magnetic field but no electric field in the direction of propagation. Thus, a TE mode can be considered a beam of electromagnetic (EM) radiation measured in a plane perpendicular or transverse to the propagation direction of the beam. It will also be understood that the modes are quantized in the waveguide, where only certain optical modes can exist in the waveguide. Thus, the EM beam includes a fundamental mode, which is the desired signal, and one or more higher-order modes or non-fundamental modes. The higher-order modes are typically introduced by mode conversion, which can occur, for example, with coupling devices that couple the optical signal between a fiber or a source and the integrated waveguide.

The higher-order modes are undesirable at least because their energy can interfere with each other or with themselves, causing sinusoidal variations or “ripples” in the output power of the fundamental mode as a function of wavelength. The ripples in the spectrum of an integrated optical device can occur due to reflections and multimode interference. Ripples can be several dB in amplitude, a few nm or less in period, and can vary quite rapidly with wavelength. Thus, higher-order modes result in undesirably large statistical deviation in output power, especially if the actual laser wavelength has some statistical deviation from the designed wavelength, as can commonly occur with integrated optical components.

Single-mode waveguides are ostensibly single-mode because they are lossier for higher-order modes than for the fundamental mode. However, in practice there can be a significant amount of energy in the higher-order modes even within a single-mode waveguide, which is sufficient to degrade the output signal of the fundamental mode. Thus, the mere composition of a single-mode waveguide is not sufficient to adequately reduce the effects of higher-order modes.

FIG. 1C illustrates a wave pattern of a higher-order mode propagation in the slab for the prior art rib waveguide design of FIG. 1A. Cross-section 106 illustrates a simulation of a second order TE mode propagated in circuit 102 in conjunction with fundamental mode 150. The contour mapping of cross-section 106 illustrates one example of a higher-order optical mode 160, where energy falls off with larger circumferences of the contour. As illustrated, the primary energy of this higher order mode propagates via slab 120 (with energy concentrated in the slab on either side of the rib), and is not adequately constrained by rib 110 as fundamental mode 150 is.

One technique that has been used to suppress higher order modes in the slab is to apply heavy doping to the slab to absorb the light energy in the slab, while leaving the rib and its vicinity undoped. Such a doping technique requires additional lithography and processing, which adds cost. Furthermore, heavy doping in the slab may absorb energy from the fundamental mode.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIGS. 1A-1C illustrate a prior art rib waveguide design, which produces a fundamental mode in the rib waveguide and higher-order modes in the waveguide slab.

FIGS. 2A-2C illustrate embodiments of optical circuits having various different edge designs to provide geometric disruption features to a waveguide.

FIGS. 3A-3C illustrate embodiments of optical circuits having various different edge designs to provide geometric disruption features to a waveguide.

FIG. 4 is a block diagram of an embodiment of a system in which optical circuits with geometric disruption features are employed.

FIG. 5 is a block diagram of an embodiment of optical circuits having various different edge designs, including optical circuits with geometric disruption features.

FIG. 6 is a diagrammatic representation of an embodiment of power as a function of wavelength for optical circuits with various edge designs of FIG. 5, including optical circuits with geometric disruption features.

FIG. 7A is a diagrammatic representation of an embodiment of ripple amplitude distribution for samples of optical circuits with various edge designs of FIG. 5, including optical circuits with geometric disruption features.

FIG. 7B is a diagrammatic representation of an embodiment of measured power distribution for samples of optical circuits with various edge designs of FIG. 5, including optical circuits with geometric disruption features.

FIG. 8 is a flow diagram of an embodiment of a process for creating optics with higher-order mode frustration.

FIG. 9 is a block diagram of an embodiment of a computing system in which optics with higher-order mode frustration can be implemented.

FIG. 10 is a block diagram of an embodiment of a mobile device in which optics with higher-order mode frustration can be implemented.

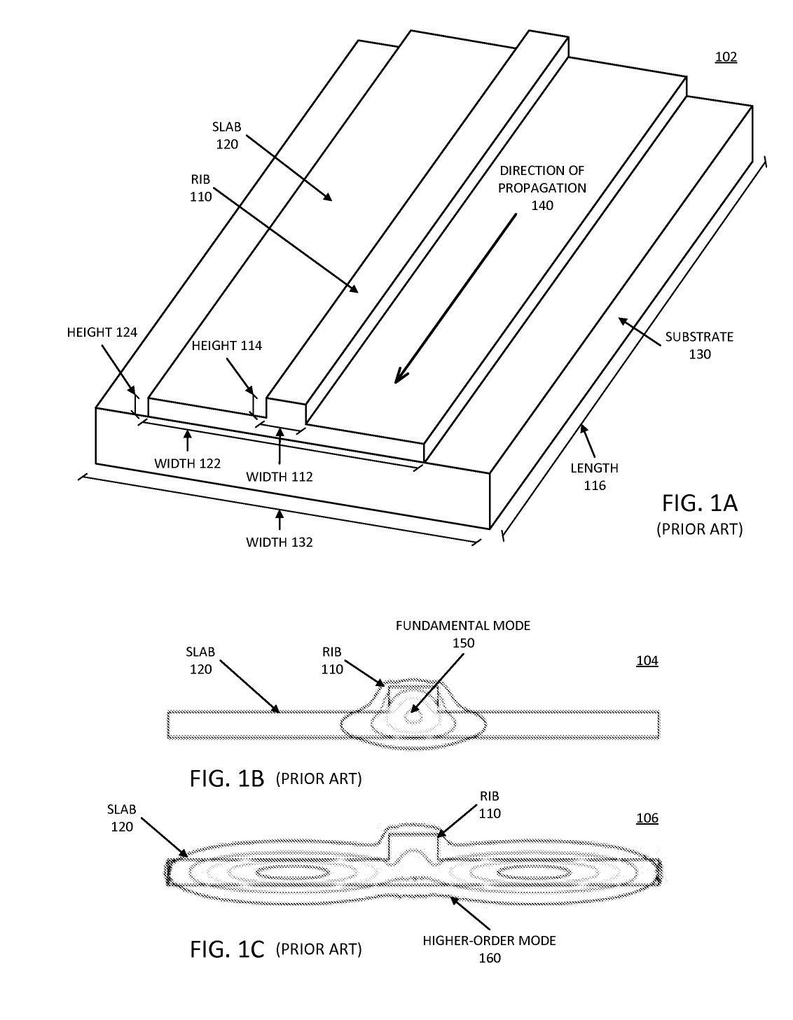

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a rib waveguide is integrated on a semiconductor slab that includes geometric disruption features along an edge of the slab in the direction of propagation of the optical signal via the rib waveguide. The geometric disruption features scatter optical modes in the slab that are not the fundamental mode, without significantly impacting the fundamental optical mode that propagates primarily in the rib waveguide. The rib waveguide refers to a rib or ridge of semiconductor material that has a width to constrain the fundamental mode, and the fundamental mode primarily propagates through the rib waveguide, with some of the energy propagated via the slab. The slab or waveguide slab refers to a slab of semiconductor material on which the rib waveguide is processed. The combined height of the slab and the rib constrain the fundamental optical mode vertically, and the width of the rib constrains the fundamental optical mode horizontally. The width of the slab is wider than the width of the rib.

Higher-order optical modes are typically created during mode conversion, when the optical signal is interfaced from one waveguide or connector to another waveguide or connector. Energy from the higher-order optical modes will propagate in the slab without the geometric disruption features. The geometric disruptions scatter the higher-order optical modes, preventing their propagation in the slab. In one embodiment, the geometric disruptions can include serration features in one or both edges of the slab. The scattering of the higher-order optical modes with the geometric disruptions can filter out the ripples or sinusoidal oscillations in transmission of the fundamental optical signal. The scattering of the higher-order modes can suppress reflections and multi-mode interference. Thus, engineering the shape of the slab edge can reduce ripple amplitude by several dB.

In one embodiment, in general, the geometric disruption features provide jagged edges in the x-y plane of the slab to scatter the higher-order modes out of the slab. In one embodiment, the geometric disruption features include serrations. The serrations can be evenly spaced or having irregular or randomized or pseudo-random spacing. The serrations can have sawtooth, comb, or sinusoidal shapes, or other shapes. In one embodiment, the feature size of the serrations is greater than the width of the rib. The geometric disruption features can be applied to waveguides for on-chip or off-chip lasers or light sources. Regardless of light source or placement of the waveguide, the geometric disruptions in the waveguide can provide a mechanism to correct for mode conversion. The design or shape of the geometric features in the x-y architecture or the x-y extents of a waveguide slab of a rib waveguide in accordance what is described herein will scatter higher-order modes from the waveguide while not significantly impacting the fundamental mode.

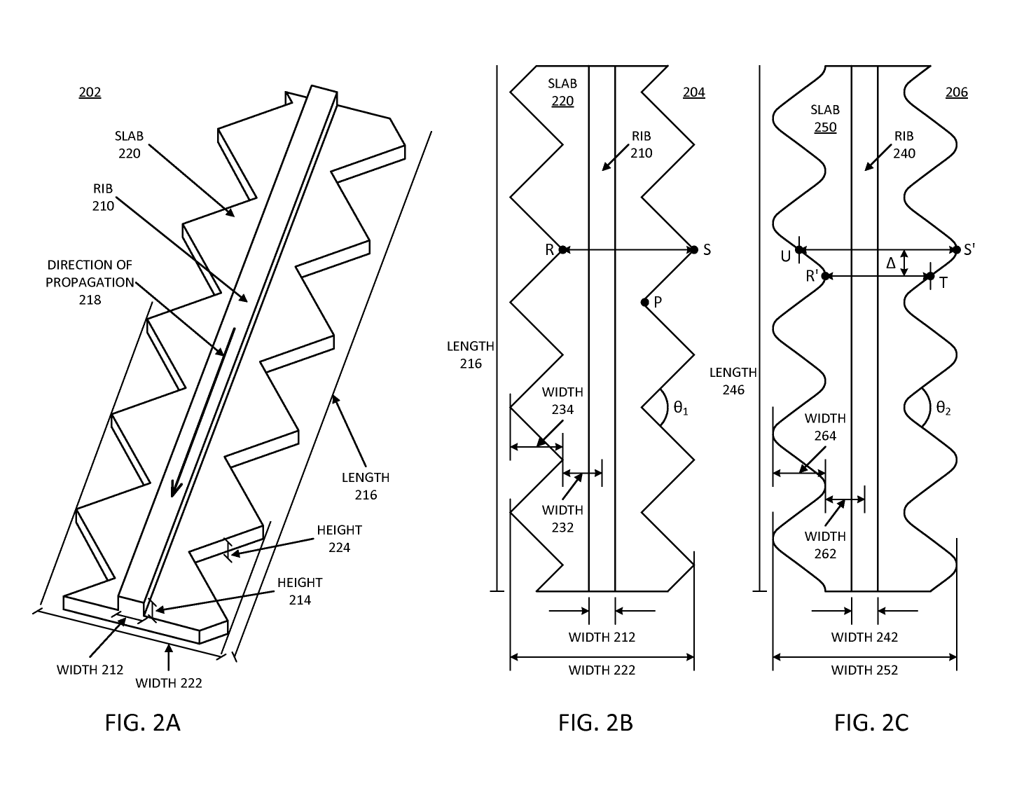

FIGS. 2A-2B illustrate different perspectives of an optical circuit having a sawtooth edge pattern to operate as geometric disruption features in the waveguide slab of a rib waveguide. Optical circuit 202 or simply circuit 202 of FIG. 2A represents a portion of a rib waveguide with geometric disruption features, and is shown from a perspective view. Circuit 204 of FIG. 2B represents the portion of the rib waveguide of FIG. 2A from a view orthogonal to a semiconductor substrate on which the rib waveguide is processed.

Rib 210 is a rib waveguide. Rib 210 is a rib of semiconductor material having a height 214 above slab 220, and having a width 212 that is smaller than width 222 of slab 220. Width 212 of rib 210 constrains an optical signal in the direction of propagation 218 in which the electromagnetic energy transmits along the waveguide. Width 222 is measured from one extent of one edge of slab 220 to the extent of the other edge of slab 220. It will be understood that the features are not necessarily shown to scale, but certain features may be out of proportion for purposes of illustration.

In one embodiment, the edges of circuits 202 and 204 can be considered to be “serrated.” Serration refers to geometric shapes present along the edge of slab 220. The edges are considered to have geometric patterns or geometric features due to having shapes with facets and angles. The serrations illustrated in circuits 202 and 204 can be considered a sawtooth pattern, or a triangular pattern. It will be understood that in addition to or alternatively to a sawtooth pattern, the geometric features can include sinusoidal features, square or rectangular features, half-circles, and/or other shapes. Serration refers to the fact that there is spacing between the features to allow the facets to be exposed, whether the spacing is regular or irregular, and whether the facets are regular or irregular.

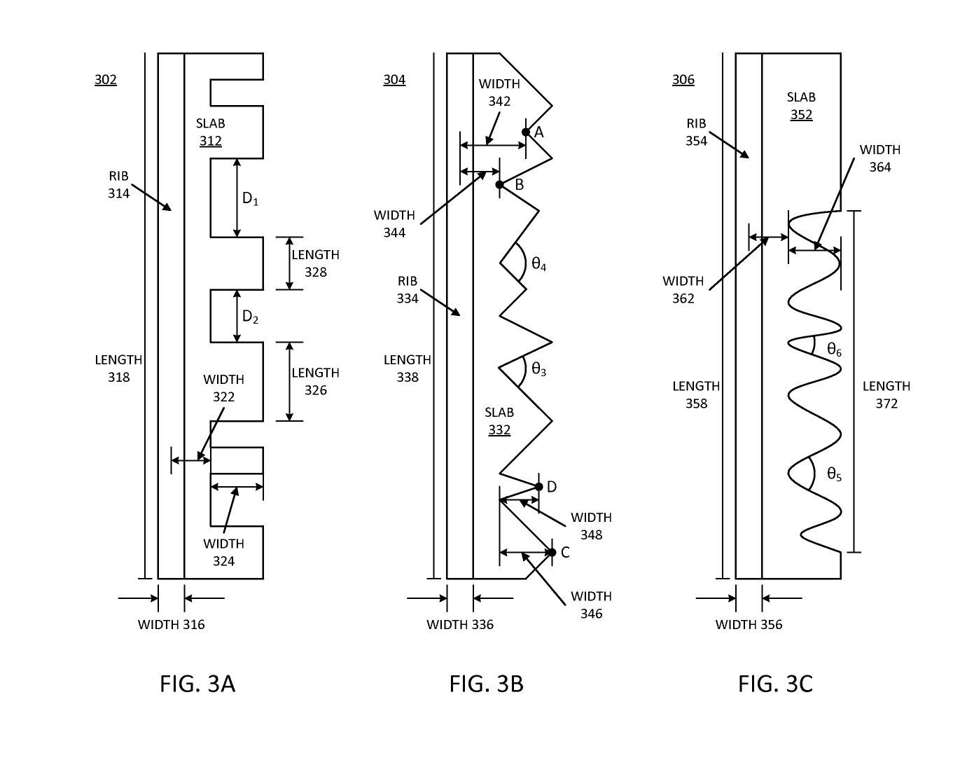

In one embodiment, as illustrated, all serrated features in slab 220 extend to the same width. In another embodiment, certain extents extend further than others (see, for example, FIG. 3B). Slab 220 includes a height 224 above a semiconductor substrate (not specifically shown) on which the rib waveguide is integrated. In one embodiment, height 224 is less than height 214. In one embodiment, rib 210 and slab 220 extend in the direction of propagation 218 for a length 218. The length of the rib and slab in an actual implementation would typically much greater than what is shown relative to the dimensions of the features in circuits 202 and 204. Thus, length 216 illustrates a segment or a portion of a rib waveguide.

Referring to circuit 204, the circuit is designed with width 232, which measures a distance of the innermost point of the serrations of the edge of slab 220 to the center of rib 210. Width 232 should be selected to limit the interaction of the serrations with the fundamental mode that propagates along rib 210. Thus, the serrations can be positioned far enough away from rib 210 to cause the interaction of the fundamental optical mode with the serrations to be negligible. Even when the serrations have a negligible effect on the fundamental mode, the serrations make the undesirable higher-order modes existing in slab 220 to be highly lossy since they must propagate through many bounces at sharp angles off the serration facets or the faces of the disruptions features.

In one embodiment, slab 220 includes serrations on both sides of rib 210. In one embodiment, serrations on both sides of rib 210 are symmetrical as illustrated in circuit 204. The serrations in circuit 204 are both symmetrical and offset from each other. Point R represents a point on one side where the edge is at its closest point to rib 210, with point R being directly across from or aligned with the waveguide from point S, which is on the edge where the other side is at its point of furthest distance from rib 210. Such offsets can reduce the chance of Fabry-Perot effects that may be evident if, for instance, there was no offset. Thus, if point R was directly across from point P, which is where the side with point S is at its closest to rib 210.

It will be understood that the serrations in circuits 202 and 204 are regular, meaning there is regular spacing and common angles (within processing tolerances) from one geometric edge feature to the next. It could be said that the geometric features on the edges of circuit 204 have periodicity. Thus, in one embodiment, all intersections of the serrations have an angle θ₁ between them. In one embodiment, angle θ₁ is 90 degrees. In one embodiment, θ₁ is less than or greater than 90 degrees. When the angles between the serration teeth are different, the serration can be considered irregular. Thus, circuit 204 could be made with irregular serrations. While circuit samples have measured desired ripple suppression with regular teeth or regular serrations, such as those illustrated in circuit 204, irregular serrations may be advantageous in avoiding periodic reflections which can sum coherently.

Circuit 204 illustrates serrations along the entire length 216 of the waveguide segment. In one embodiment, geometric disruption feature or geometric edge features can be placed along the entire length of the slab. In one embodiment, geometric disruption feature or geometric edge features are not placed along the entire length of the waveguide, but are placed only at discrete locations as discrete mode filters. Thus, the waveguide can have one or more segments or portions that have geometric disruption features in the edges for a length 216, and other portions of the waveguide that have flat or smooth (non-serrated) edges. In one embodiment, the waveguide can include alternating regions of geometric disruptions features adjacent regions with no such edge features. The regions with and without geometric disruption features are not necessarily the same length. It will be understood that length refers to a distance parallel to the direction of propagation 216.

FIG. 2C illustrates optical circuit 206 having a sinusoidal edge design to provide geometric disruption features to a waveguide. Circuit 206 includes rib 240 integrated on slab 250. Rib 240 has a width 242, and slab 250 has a width 252, which is the distance between extremes or extents of slab 250. It will be understood that rib 240 could be identical to rib 210 of circuit 204 (for example, where width 242 is equal to 212 and other elements of the ribs are also identical). Slab 250 can be made of the same material and have a width 252 that is equal to width 222. Slab 220 has serrations with a minimum width 262 and a maximum width 264 from the center of rib 240, which could be the same or different from corresponding widths 232 and 234 of circuit 204. Thus, in one embodiment, the only difference between circuit 206 and circuit 204 is the shape of the serration features (or the serration teeth) and the offset between the serrations on opposite edges. In one embodiment, width 242, width 252, width 262, width 264, length 246, and/or angle θ₂ is different from corresponding features of circuit 204.

Regarding the shape of the serration features, it will be observed that the edges of circuit 206 are smoother than the edges of circuit 204, where the serration teeth are sinusoidal shapes instead of triangular or sawtooth shapes. In one embodiment, the edges on either side of rib 240 can be considered either identical and offset from each other or mirror images of each other (as with circuit 204), or mirror images and offset from each other. In circuit 206 point R′ represents a point on one side where the edge is at its closest point to rib 240, and point S′ represents a point on the other side where the edge is at its point of furthest distance from rib 240. It will be observed that R′ and S′ are not directly across the waveguide from each other. Rather, point R′ is directly across from point T, which is on the same side as point S′, but not at either the minimum or maximum distance on the edge from rib 240. Similarly, point S′ is directly across from point U, which is on the same side as point R′, but not at either the minimum or maximum distance on the edge from rib 240. Thus, in one embodiment, there is a delta (A) along the direction of propagation (along length 246) between the minimum of one side and the maximum of the other side.

It will be understood that spacing from one geometric disruption feature to another can be regular or irregular. In one embodiment, sizes and shapes and even the edge pattern type (e.g., sinusoidal, sawtooth, square, or others) can be regular or irregular. Whatever spacing and sizes are selected, spacing and other dimensions that are multiples of the wavelength of the fundamental mode should be avoided. Dimensions that are multiples of the fundamental mode wavelength can cause unwanted resonant effects from periodic reflections.

The following descriptions refer to optical circuits having various different edge designs to provide geometric disruption features to a waveguide. More specifically referring to FIG. 3A, circuit 302 illustrates a portion of a waveguide, where the illustrated portion has a length 318. The waveguide includes slab 312 and rib 314 integrated on slab 312. Slab 312 includes serration features on at least one edge, as illustrated. Slab 312 may or may not have serration features on the other side of rib 314 along length 318. The pattern of geometric features on the edge of circuit 302 can be referred to as a square or square-wave pattern, or a comb pattern. Similar to the sawtooth teeth of circuits 204 and 206 illustrated above, the square geometric features of circuit 302 could be regular in size and/or spacing. In one embodiment, either the sizing of the teeth or the spacing of the teeth or both are irregular. FIG. 3A includes irregular spacing and teeth sizing for purposes of illustration, but is not limiting.

As illustrated, the edge of slab 312 has two teeth with length dimensions of 326 and 328, which are different from each other. Although referred to as “length” 326 and “length 328,” the measurements referenced can be understood as describing a “width” feature of the teeth. However, for purposes of consistency in description, the dimensions referred to as 326 and 328 are “length” since they are along the same axis as length 318. Width 324 of the teeth refers to a measurement extending from a minimum point (closest to rib 314) of the geometric features to a maximum point (furthest from rib 314). The width of slab 312 includes at least width 322 from the middle of rib 314 to the minimum point of the edge serration features plus width 324 to the maximum point of the edge. Width 316 of rib 314 is illustrated merely for purposes of relative comparison that the slab is wider than the rib, without necessarily being to scale.

More specifically referring to FIG. 3B, circuit 304 illustrates a portion of a waveguide, where the illustrated portion has a length 338. The waveguide includes slab 332 and rib 334 integrated on slab 332. Slab 332 includes serration features on at least one edge, as illustrated. Slab 332 may or may not have serration features on the other side of rib 334 along length 338. Rib 334 is illustrated having a width 336, for purposes of relative comparison, where the width of slab 332 is greater than rib 334, although the illustration is not necessarily to scale.

The pattern of geometric features on the edge of circuit 304 shows many variations of a sawtooth pattern. Each of the variations of the sawtooth pattern could be implemented along an edge as geometric disruption features, but a practical, production design would not necessarily include all the variations illustrated in circuit 304 in a single waveguide segment length 338, or not necessarily all feature variations on the same waveguide. The feature variations are illustrated for purposes of description, and can be used in part or in whole, and/or combined with other feature variations.

More particularly, circuit 304 illustrates variations in both angle between individual “teeth” or geometric extents, as well as variations in size of the teeth including variations in minimum and maximum points from rib 334. It will be observed from circuit 304 that angle θ₃ is different from angle θ₄. The difference in angles accounts for differences length of individual teeth (where length refers to a dimension along the same axis as length 338). Additionally, circuit 304 illustrates design or pattern differences in certain minimum points associated with different edge features. For example, point A is a minimum relative to the teeth adjacent it, but it has width 342, which is greater than width 344 of point B, because point A is further from rib 334 than point B. Additionally, circuit 304 illustrates design or pattern difference in certain maximum points associated with different edge features. For example, point C is at a furthest edge point on slab 332, and has an associated width 346, which is greater than width 348 for point D, which is a maximum point for its edge feature, but does not extend as far as point C. Again, it will be understood that these features are for purposes of illustration. In one embodiment, an edge pattern includes feature points that have different maximum and/or minimum dimensions than other feature points. Such features could be patterned randomly, pseudo-randomly, or can be applied as variations that repeat in a regular pattern.

More specifically referring to FIG. 3C, circuit 306 illustrates a portion of a waveguide, where the illustrated portion has a length 358. The waveguide of circuit 306 includes slab 352 and rib 354 integrated on slab 352. Slab 352 includes serration features on at least one edge, as illustrated. Slab 352 may or may not have serration features on the other side of rib 354 along length 358. Rib 354 is illustrated having a width 356, for purposes of relative comparison, where the width of slab 352 is greater than rib 354, although the illustration is not necessarily to scale.

The pattern of geometric features on the edge of circuit 306 shows multiple variations of a sinusoidal pattern. Each of the variations of the could be implemented along an edge as geometric disruption features, but a practical, production design would not necessarily include all the variations illustrated in circuit 306 in a single waveguide segment length 358, or not necessarily all feature variations on the same waveguide. The feature variations are illustrated for purposes of description, and can be used in part or in whole, and/or combined with other feature variations.

More particularly, circuit 306 illustrates variations in both angle between individual “teeth” or geometric extents, as well as variations in size of the length dimension of teeth, referring to the dimension along the same axis as length 358. It will be observed that differences in the length dimension changes the relative angles between differently sized teeth, as seen by the fact that angle θ₅ is different from angle θ₆. In one embodiment in circuit 306, all serration features share a common minimum dimension, which is illustrated by width 362, and they share a common maximum point, which is illustrated by width 364. In one embodiment, circuit 306 includes serration features for segment length 372, which is not the entire length 358. Thus, in one embodiment, serration features can be used for discrete segments of the waveguide.

As illustrated in circuit 306, the segment of serration features is adjacent segments that have a width dimension equal to the maximum dimension of the serration features in segment 372. In one embodiment, the segment of serration features has a different maximum width dimension than a segment that is flat or smooth and has no serration or geometric disruption features. In one embodiment, the serration features extend further from rib 354 than the portion of the edge without serration features. In one embodiment, the edge portion without serration features has a larger width dimension than the largest width dimension of the serration features. In one embodiment, the edge portion without serration features has a width equal to width 362. In one embodiment, the edge portion with serration features has a width greater than width 362, but not width 364 greater than width 362.

In one embodiment, the waveguide includes alternating sections of edge that have serration features and edge that does not have serrations. In one embodiment, the waveguide includes a segment that has serration features on one side opposite an edge that does not have serration features, but has a minimum width (e.g., width 362). The serration features can extend an entire length of the waveguide, or be positioned only in discrete locations.

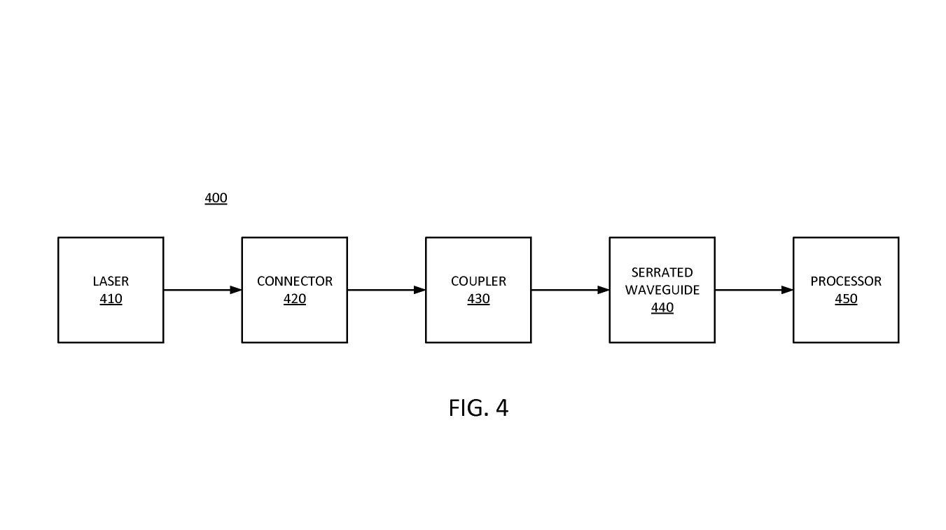

FIG. 4 is a block diagram of a system in which optical circuits with geometric disruption features are employed. System 400 illustrates one example of a system in which a waveguide with geometric disruption features can be implemented, and it will be understood that other systems could also use such a waveguide. Laser 410 represents a light source that generates the optical signal. In one embodiment, laser 410 is an on-chip laser that is integrated on the same substrate as the waveguide that will propagate the light. In one embodiment, laser 410 is an off-chip laser that couples to the waveguide via one or more interfaces. In one embodiment, system 400 includes connector 420 or other mechanical device that interfaces laser 410 with the waveguide. Connector 420 can include one or more facets that redirect light (e.g., horizontal to vertical or vice-versa). In one embodiment, connector 420 can include a fiber waveguide to transmit the optical signal to coupler 430.

In one embodiment, system 400 includes couple 430 to couple light from laser 410 to waveguide 440. Coupler 430 can be, for example, a grating coupler, a TIR (total internal reflection) surface, or other coupler. In one embodiment, coupler 430 is part of connector 420. Waveguide 440 is a serrated waveguide or a waveguide with geometric disruption features on one or both edges, in accordance with any embodiment described herein. Waveguide 440 propagates the optical signal to a target device for processing. Waveguide 440 suppresses energy from non-fundamental modes by scattering the non-fundamental modes with edge features in the slab.

In one embodiment, system 400 includes processor 450 as a target of the optical signal transmitted via waveguide 440. Processor 450 can be an application-specific processor, such as a processor that processes optical communication, or an optical to electrical conversion engine. In one embodiment, processor 450 is a system processor that executes an operating system and controls the operation of an electronic device, and can thus be any type of processor. In such an embodiment, additional hardware may be needed to interface waveguide 440 to processor 450 to convey the optical signal. In one embodiment, processor 450 includes one or more waveguides 440 integrated onto it, such as in an SoC (system on a chip) configuration, where one or more optical transmissions occurs on a system substrate, which is a common substrate on which a processor die is integrated with other components. Such a processor can include one or more interfaces to a connector that in turn interfaces with a fiber connector, and can exchange an optical signal between processor 450 and another device or chip off-chip to the processor.

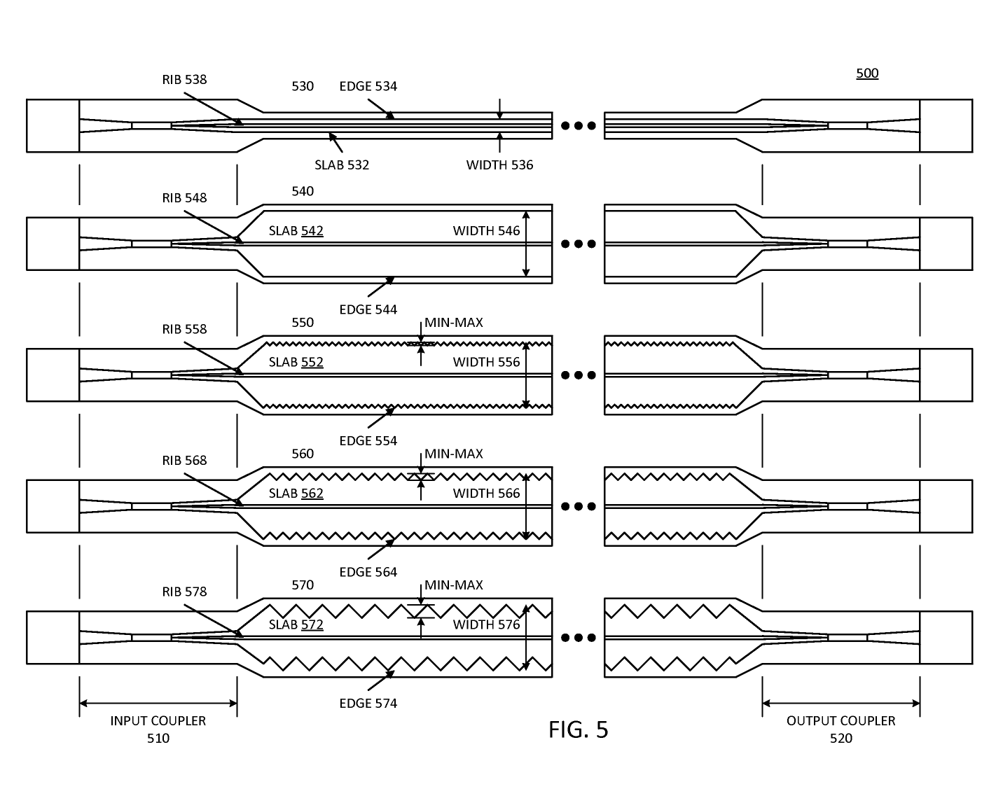

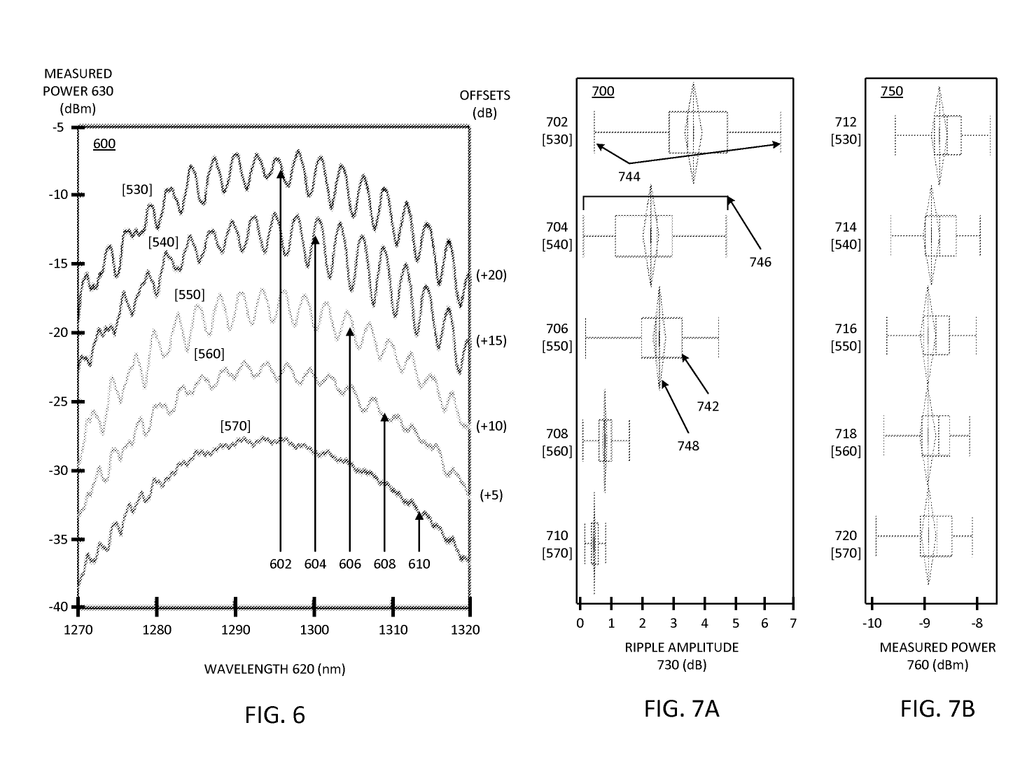

FIG. 5 is a block diagram of optical circuits having various different edge designs, including optical circuits with geometric disruption features. Diagram 500 represents a test system with multiple devices fabricated for testing. Each different optical circuit represents multiple (dozens) of circuits of each type that were fabricated and tested. FIGS. 6, 7A, and 7B provide diagrammatic representations of some of the results of the testing.

Optical circuits 530, 540, 550, 560, and 570 each include a respective slab 532, 542, 552, 562, 572 and rib 538, 548, 558, 568, and 578. Each optical circuit was tested by coupling broadband light from a super-luminescent light emitting diode (SLED) via input coupler portion 510. The optical signal propagated down each waveguide (from left to right in accordance with the orientation of diagram 500) to output coupler 520, where the output spectrum was measured by an optical signal analyzer (OSA). All waveguides had a rib width of 400 nm and a total length of 4.5 mm (distance from input coupler 510 to output coupler 520). Circuit 530 has a slab width 536 equal to 9.5 μm. The other waveguides have slab widths of 546, 556, 566, and 576, all equal to 40 μm.

Circuit 530 and circuit 540 have no serrations on edges 534 and 544, respectively. The serrations of circuits 550, 560, and 570 are intentionally exaggerated to illustrate the serrations. The serrations can be seen as being of the same design, but with different widths from the minimum point to the maximum point (e.g., such as width 234 of FIG. 2B) of the geometric shaping of edges 554, 564, and 574. The actual devices were fabricated with dimensions as follows: circuit 550 had a min-max distance of 1 μm; circuit 560 had a min-max distance of 4 μm; and, circuit 570 had a min-max distance of 10 μm. The serrations of circuits 550, 560, and 570 were all sawtooth with a θ=90°, referring to the angle of intersection between the facets of adjacent teeth.

FIG. 6 is a diagrammatic representation of an embodiment of power as a function of wavelength for optical circuits with various edge designs of FIG. 5, including optical circuits with geometric disruption features. For purposes of illustration of the results, the typical spectra of the different waveguide designs are vertically offset on the graph 600 for clarity. Thus, the top spectrum corresponds to circuit 530, and each corresponding circuit from top to bottom down to circuit 570 at the bottom of graph 600. Thus, spectrum 602 corresponds to circuit 530, spectrum 604 corresponds to circuit 540, spectrum 606 corresponds to circuit 550, spectrum 608 corresponds to circuit 560, and spectrum 610 corresponds to circuit 570.

Graph 600 illustrates measured power 630 (in dBm) versus wavelength 620 (in nm). The ripples in the spectra occur due to reflections and multi-mode interference. Although vertically offset on the graph, it can be seen that the ripples can measure several dB in amplitude, a few nm or less in period, and can vary quite rapidly with wavelength. The ripples especially in spectra 602 and 604 illustrate the resulting undesirably large statistical deviation in output power. Such deviation can be worsened if the actual laser wavelength has statistical deviation from the designed wavelength, as can be common in some laser devices.

As noted, spectra 602 and 604 show significant ripples, even despite being single-mode waveguides. Looking to spectrum 606, it will be observed that even small edge features such as those found in circuit 550 can significantly reduce the ripple amplitude. Larger feature sizes such as those in circuit 560 can improve the ripple suppression, as seen in spectrum 608. Finally, as seen in spectrum 610, the larger feature sizes of circuit 570 can be very effective at suppressing the undesired ripples. It will be understood that these tests demonstrate only one pattern type (sawtooth, mirrored on opposing edges of the slab). Other patterns and feature combinations can also significantly suppress the ripples caused by higher order modes by scattering the modes in the slab of the rib waveguide.

FIG. 7A is a diagrammatic representation of an embodiment of ripple amplitude distribution for samples of optical circuits with various edge designs of FIG. 5, including optical circuits with geometric disruption features. Graph 700 illustrates one example of the distribution of ripple amplitudes from all devices tested, whose average or typical outputs are shown in graph 600 of FIG. 6. Distribution 702 corresponds to devices of circuit type 530 and spectrum 602, distribution 704 corresponds to devices of circuit type 540 and spectrum 604, distribution 706 corresponds to devices of circuit type 550 and spectrum 606, distribution 708 corresponds to devices of circuit type 560 and spectrum 608, and distribution 710 corresponds to devices of circuit type 570 and spectrum 610. In general it will be observed how ripple amplitude 730 reduced for devices with a waveguide having geometric disruption features.

More specifically referring to graph 700, ripple amplitude 730 was extracted from the amplitude of the relevant peak in the Fourier domain of spectra 602, 604, 606, 608, and 610, where distributions 702, 704, 706, 708, and 710, respectively, illustrate statistical interpretations of the plotting of the extracted information. In general the serrated waveguides demonstrate lower ripple amplitude, particularly as the min-max distance increases (for example, circuit 570 shows better performance than circuit 550, which shows better performance than circuit 540).

Graph 700 is read according to the following. Distributions 702, 704, 706, 708, and 710 are each outlier box plots, which summarize the distribution of points for the corresponding spectrum. Each distribution includes a box, such as box 742, which represents the grouping of points from the first to third quartiles, or the 25% to 75% marks for the points. The end lines, such as end lines 744, represent the 5% and 95% marks. Thus, span 746 illustrates the spread of points from 5% to 95%. The diamonds, such as diamond 748, are mean diamonds, which represent a sample mean and confidence interval. The bisection of the diamond represents a computed statistical mean, and the area within the diamond represents a 95% confidence interval. Thus, it will be observed that the very tight spread of distribution 710 corresponding to circuit 570 provides much greater statistical reliability than the looser spread of distribution 704 corresponding to circuit 540.

FIG. 7B is a diagrammatic representation of an embodiment of measured power distribution for samples of optical circuits with various edge designs of FIG. 5, including optical circuits with geometric disruption features. Graph 750 illustrates one example of the distribution of measured power from all devices tested. Graph 750 is read in accordance with the same explanation provided above with respect to graph 700. Distribution 712 corresponds to devices of circuit type 530 and spectrum 602, distribution 714 corresponds to devices of circuit type 540 and spectrum 604, distribution 716 corresponds to devices of circuit type 550 and spectrum 606, distribution 718 corresponds to devices of circuit type 560 and spectrum 608, and distribution 720 corresponds to devices of circuit type 570 and spectrum 610. In general graph 750 illustrates that measured power 760 is not significantly impacted by the introduction of geometric disruption features in the edges of the waveguide slab. It will be observed that graph 700 of FIG. 7A illustrates ripple distribution, where ripple amplitude 730 is caused by undesired higher-order optical modes; thus, tighter distributions are desired. Graph 750 of FIG. 7B illustrates power distribution, where measured power 760 is generated by the desired fundamental optical mode. Thus, it will be observed that the distribution plots are nearly identical for each circuit. Graph 750 illustrates that measured power has no statistical variation for waveguides with geometric disruption features in the edges. Note that most of the spread in transmission distribution in graph 750 is due to wafer center-to-edge variation in the efficiency of the grating coupler. For a given device at a given radial location, the expected distribution of transmissions is expected to be much smaller.

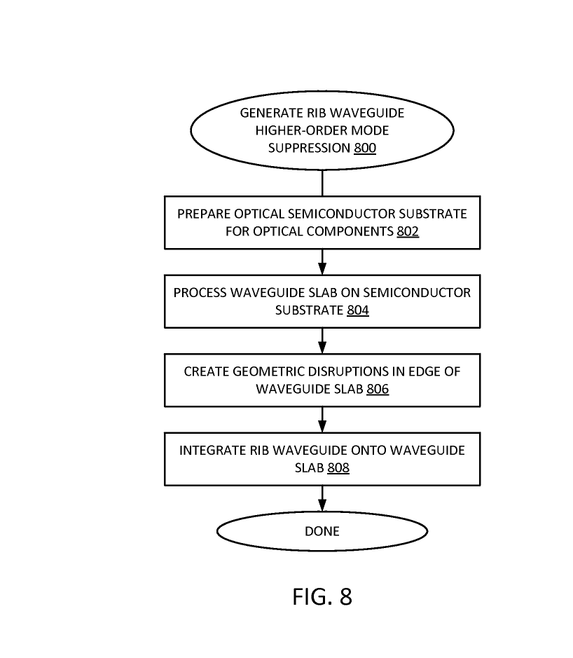

FIG. 8 is a flow diagram of an embodiment of a process for creating optics with higher-order mode frustration. Process 800 generates higher-order or non-fundamental mode suppression in a rib waveguide. A manufacturer or manufacturing entity prepares an optical semiconductor substrate for optical components, 802. In one embodiment, the semiconductor substrate includes a silicon-on-insulator (SOI) component for use with silicon-based photonics. In one embodiment, non-silicon substrates can be used, or elements of both silicon and non-silicon can be combined.

The manufacturer processes a waveguide slab on the semiconductor substrate, 804. In one embodiment, the waveguide slab is processed by etching semiconductor material over the substrate in selected areas to create the basic structure dimensions (e.g., width and length) for the waveguide. In one embodiment, manufacturing etches the slab through to the underlying substrate (e.g., through a layer of semiconductor material to a buried insulator) to provide separation of different waveguides or waveguide channels.

The manufacturer creates geometric disruptions in the edge of the waveguide slab, 806. The geometric disruptions can be in accordance with any embodiment described herein. The geometric disruption features can include regular or irregular patterns, variations in dimensions within a pattern, random or pseudo-random shapes, or other edges, which can generically be referred to as serrations. The edges can have squared teeth, triangular teeth, sinusoidal teeth, semicircular teeth, or other shape. In one embodiment, the manufacturing creates the geometric shapes in the edges for an entire length of the waveguide. In one embodiment, the manufacturing creates one or more geometric shape segments at selected locations as discrete filters in the waveguide. In one embodiment, the manufacturing creates geometric features in both edges of the waveguide slab.

The manufacturer integrates a rib waveguide on the waveguide slab, 808. In one embodiment, the rib waveguide can be formed by etching material from the slab to leave the rib having a height greater than the slab. In one embodiment, the rib could be grown or deposited on the slab.

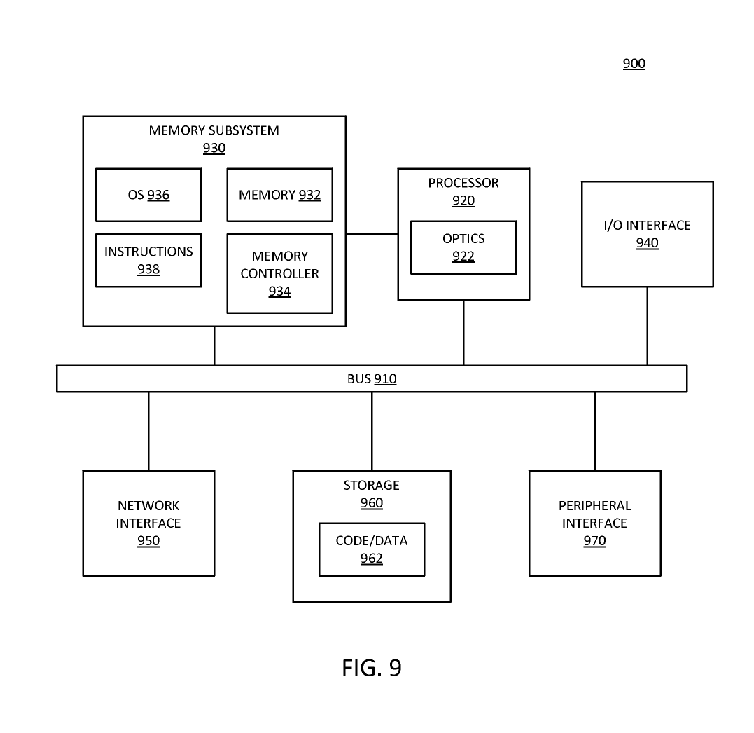

FIG. 9 is a block diagram of an embodiment of a computing system in which optics with higher-order mode frustration can be implemented. System 900 represents a computing device in accordance with any embodiment described herein, and can be a laptop computer, a desktop computer, a server, a gaming or entertainment control system, a scanner, copier, printer, routing or switching device, or other electronic device. System 900 includes processor 920, which provides processing, operation management, and execution of instructions for system 900. Processor 920 can include any type of microprocessor, central processing unit (CPU), processing core, or other processing hardware to provide processing for system 900. Processor 920 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 930 represents the main memory of system 900, and provides temporary storage for code to be executed by processor 920, or data values to be used in executing a routine. Memory subsystem 930 can include one or more memory devices such as read-only memory (ROM), flash memory, one or more varieties of random access memory (RAM), or other memory devices, or a combination of such devices. Memory subsystem 930 stores and hosts, among other things, operating system (OS) 936 to provide a software platform for execution of instructions in system 900. Additionally, other instructions 938 are stored and executed from memory subsystem 930 to provide the logic and the processing of system 900. OS 936 and instructions 938 are executed by processor 920. Memory subsystem 930 includes memory device 932 where it stores data, instructions, programs, or other items. In one embodiment, memory subsystem includes memory controller 934, which is a memory controller to generate and issue commands to memory device 932. It will be understood that memory controller 934 could be a physical part of processor 920.

Processor 920 and memory subsystem 930 are coupled to bus/bus system 910. Bus 910 is an abstraction that represents any one or more separate physical buses, communication lines/interfaces, and/or point-to-point connections, connected by appropriate bridges, adapters, and/or controllers. Therefore, bus 910 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 910 can also correspond to interfaces in network interface 950.

System 900 also includes one or more input/output (I/O) interface(s) 940, network interface 950, one or more internal mass storage device(s) 960, and peripheral interface 970 coupled to bus 910. I/O interface 940 can include one or more interface components through which a user interacts with system 900 (e.g., video, audio, and/or alphanumeric interfacing). Network interface 950 provides system 900 the ability to communicate with remote devices (e.g., servers, other computing devices) over one or more networks. Network interface 950 can include an Ethernet adapter, wireless interconnection components, USB (universal serial bus), or other wired or wireless standards-based or proprietary interfaces.

Storage 960 can be or include any conventional medium for storing large amounts of data in a nonvolatile manner, such as one or more magnetic, solid state, or optical based disks, or a combination. Storage 960 holds code or instructions and data 962 in a persistent state (i.e., the value is retained despite interruption of power to system 900). Storage 960 can be generically considered to be a “memory,” although memory 930 is the executing or operating memory to provide instructions to processor 920. Whereas storage 960 is nonvolatile, memory 930 can include volatile memory (i.e., the value or state of the data is indeterminate if power is interrupted to system 900).

Peripheral interface 970 can include any hardware interface not specifically mentioned above. Peripherals refer generally to devices that connect dependently to system 900. A dependent connection is one where system 900 provides the software and/or hardware platform on which operation executes, and with which a user interacts.

In one embodiment, one or more components of system 900 include an integrated optical circuit with a waveguide having serration features in one or both edges. For example, processor 920 is illustrated with optics 922, which can include an integrated optical circuit with a waveguide having geometric disruption features in accordance with any embodiment described herein. The optics, whether in processor 920 or another component, have serrations in at least one edge to suppress non-fundamental modes while allowing the transmission of the fundamental optical mode without significantly impacting the fundamental optical mode. In one embodiment, optics 922 or other optics include or interface with a connector that couples the optical circuit to an optical fiber array that exchanges inter-chip signals between the integrated optics and a device off-chip to the component with the optics.

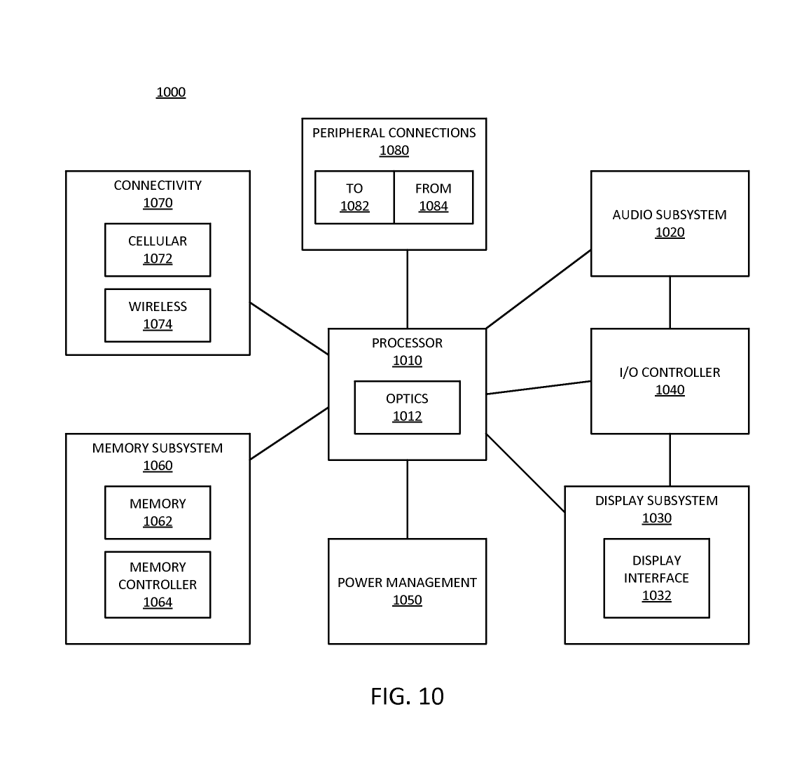

FIG. 10 is a block diagram of an embodiment of a mobile device in which optics with higher-order mode frustration can be implemented. Device 1000 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 1000.

Device 1000 includes processor 1010, which performs the primary processing operations of device 1000. Processor 1010 can include one or more physical devices, such as microprocessors, application processors, microcontrollers, programmable logic devices, or other processing means. The processing operations performed by processor 1010 include the execution of an operating platform or operating system on which applications and/or device functions are executed. The processing operations include operations related to I/O (input/output) with a human user or with other devices, operations related to power management, and/or operations related to connecting device 1000 to another device. The processing operations can also include operations related to audio I/O and/or display I/O.

In one embodiment, device 1000 includes audio subsystem 1020, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 1000, or connected to device 1000. In one embodiment, a user interacts with device 1000 by providing audio commands that are received and processed by processor 1010.

Display subsystem 1030 represents hardware (e.g., display devices) and software (e.g., drivers) components that provide a visual and/or tactile display for a user to interact with the computing device. Display subsystem 1030 includes display interface 1032, which includes the particular screen or hardware device used to provide a display to a user. In one embodiment, display interface 1032 includes logic separate from processor 1010 to perform at least some processing related to the display. In one embodiment, display subsystem 1030 includes a touchscreen device that provides both output and input to a user. In one embodiment, display subsystem 1030 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others.

I/O controller 1040 represents hardware devices and software components related to interaction with a user. I/O controller 1040 can operate to manage hardware that is part of audio subsystem 1020 and/or display subsystem 1030. Additionally, I/O controller 1040 illustrates a connection point for additional devices that connect to device 1000 through which a user might interact with the system. For example, devices that can be attached to device 1000 might include microphone devices, speaker or stereo systems, video systems or other display device, keyboard or keypad devices, or other I/O devices for use with specific applications such as card readers or other devices.

As mentioned above, I/O controller 1040 can interact with audio subsystem 1020 and/or display subsystem 1030. For example, input through a microphone or other audio device can provide input or commands for one or more applications or functions of device 1000. Additionally, audio output can be provided instead of or in addition to display output. In another example, if display subsystem includes a touchscreen, the display device also acts as an input device, which can be at least partially managed by I/O controller 1040. There can also be additional buttons or switches on device 1000 to provide I/O functions managed by I/O controller 1040.

In one embodiment, I/O controller 1040 manages devices such as accelerometers, cameras, light sensors or other environmental sensors, gyroscopes, global positioning system (GPS), or other hardware that can be included in device 1000. The input can be part of direct user interaction, as well as providing environmental input to the system to influence its operations (such as filtering for noise, adjusting displays for brightness detection, applying a flash for a camera, or other features). In one embodiment, device 1000 includes power management 1050 that manages battery power usage, charging of the battery, and features related to power saving operation.

Memory subsystem 1060 includes memory device(s) 1062 for storing information in device 1000. Memory subsystem 1060 can include nonvolatile (state does not change if power to the memory device is interrupted) and/or volatile (state is indeterminate if power to the memory device is interrupted) memory devices. Memory 1060 can store application data, user data, music, photos, documents, or other data, as well as system data (whether long-term or temporary) related to the execution of the applications and functions of system 1000. In one embodiment, memory subsystem 1060 includes memory controller 1064 (which could also be considered part of the control of system 1000, and could potentially be considered part of processor 1010). Memory controller 1064 includes a scheduler to generate and issue commands to memory device 1062.

Connectivity 1070 includes hardware devices (e.g., wireless and/or wired connectors and communication hardware) and software components (e.g., drivers, protocol stacks) to enable device 1000 to communicate with external devices. The external device could be separate devices, such as other computing devices, wireless access points or base stations, as well as peripherals such as headsets, printers, or other devices.

Connectivity 1070 can include multiple different types of connectivity. To generalize, device 1000 is illustrated with cellular connectivity 1072 and wireless connectivity 1074. Cellular connectivity 1072 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 1074 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 1080 include hardware interfaces and connectors, as well as software components (e.g., drivers, protocol stacks) to make peripheral connections. It will be understood that device 1000 could both be a peripheral device (“to” 1082) to other computing devices, as well as have peripheral devices (“from” 1084) connected to it. Device 1000 commonly has a “docking” connector to connect to other computing devices for purposes such as managing (e.g., downloading and/or uploading, changing, synchronizing) content on device 1000. Additionally, a docking connector can allow device 1000 to connect to certain peripherals that allow device 1000 to control content output, for example, to audiovisual or other systems.

In addition to a proprietary docking connector or other proprietary connection hardware, device 1000 can make peripheral connections 1080 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, one or more components of system 1000 include an integrated optical circuit with a waveguide having serration features in one or both edges. For example, processor 1010 is illustrated with optics 1012, which can include an integrated optical circuit with a waveguide having geometric disruption features in accordance with any embodiment described herein. The optics, whether in processor 1010 or another component, have serrations in at least one edge to suppress non-fundamental modes while allowing the transmission of the fundamental optical mode without significantly impacting the fundamental optical mode. In one embodiment, optics 1012 or other optics include or interface with a connector that couples the optical circuit to an optical fiber array that exchanges inter-chip signals between the integrated optics and a device off-chip to the component with the optics.

In one aspect, an optical circuit for conveying an optical signal includes: a rib waveguide including a semiconductor material, the rib waveguide having a first width to constrain an optical fundamental mode to be transmitted in a direction of propagation via the rib waveguide; and a semiconductor slab of the semiconductor material integrated on a substrate, the rib waveguide being disposed on the semiconductor slab, wherein the semiconductor slab has a second width and includes edges parallel to the direction of propagation of the fundamental mode, wherein the substrate has a third width, wherein the second width of the semiconductor slab as measured from one edge to the other is less than the third width of the substrate and greater than the second width of the rib waveguide, wherein the first, second, and third widths are orthogonal to the direction of propagation of the fundamental mode, and wherein at least one edge of the semiconductor slab includes geometric disruptions to scatter optical modes in the semiconductor slab other than the fundamental mode.

In one embodiment, the edge with geometric disruptions comprises a serrated edge. In one embodiment, both edges of the semiconductor slab include serrated edge patterns, and wherein the serrated edge pattern is the same on both edges. In one embodiment, a serration maximum of the serrated edge pattern on one edge is aligned with a serration minimum of the serrated edge pattern on the other edge. In one embodiment, a serration maximum of the serrated edge pattern on one edge is offset relative to a serration minimum of the serrated edge pattern on the other edge. In one embodiment, the serrated edge comprises a sawtooth pattern. In one embodiment, the serrated edge comprises regularly spaced serration features. In one embodiment, the serrated edge comprises serration features having different size and/or spacing with respect to each other. In one embodiment, the geometric disruptions are included in the edge of the waveguide slab along an entire length of the rib waveguide, the length of the rib waveguide being along the direction of propagation of the fundamental mode. In one embodiment, the geometric disruptions are included in the edge of the waveguide slab along only selected portions of an entire length of the rib waveguide, the length of the rib waveguide being along the direction of propagation of the fundamental mode. In one embodiment, the semiconductor slab has geometric disruptions on both edges.

In one aspect, a system with an optical circuit for conveying an optical signal includes: a processor having an integrated optical circuit, the integrated optical circuit including a rib waveguide including a semiconductor material, the rib waveguide having a first width to constrain an optical fundamental mode to be transmitted in a direction of propagation via the rib waveguide; and a semiconductor slab of the semiconductor material integrated on a substrate, the rib waveguide being disposed on the semiconductor slab, wherein the semiconductor slab has a second width and includes edges parallel to the direction of propagation of the fundamental mode, wherein the substrate has a third width, wherein the second width of the semiconductor slab as measured from one edge to the other is less than the third width of the substrate and greater than the second width of the rib waveguide, wherein the first, second, and third widths are orthogonal to the direction of propagation of the fundamental mode, and wherein at least one edge of the semiconductor slab includes geometric disruptions to scatter higher-order optical modes in the semiconductor slab; and a connector to couple with an optical fiber array to transfer inter-chip signals between the integrated optical circuit of the processor and a device off chip to the processor.

In one embodiment, the edge with geometric disruptions comprises an edge with a serrated edge. In one embodiment, both edges of the semiconductor slab include serrated edge patterns, and wherein the serrated edge pattern is the same on both edges. In one embodiment, the serrated edge pattern on one edge is a mirror image of the serrated edge pattern of the other edge. In one embodiment, a serration maximum of the serrated edge pattern on one edge is aligned with a serration minimum of the serrated edge pattern on the other edge. In one embodiment, a serration maximum of the serrated edge pattern on one edge is offset relative to a serration minimum of the serrated edge pattern on the other edge. In one embodiment, the serrated edge comprises a sawtooth pattern. In one embodiment, the serrated edge comprises regularly spaced serration features. In one embodiment, the serrated edge comprises serration features having different size and/or spacing with respect to each other. In one embodiment, the geometric disruptions are included in the edge of the waveguide slab along only a portion of a length of the rib waveguide, the length of the rib waveguide being along the direction of propagation of the fundamental mode. In one embodiment, the geometric disruptions are included in the edge of the waveguide slab along only selected portions of an entire length of the rib waveguide, the length of the rib waveguide being along the direction of propagation of the fundamental mode. In one embodiment, the semiconductor slab has geometric disruptions on both edges.

In one aspect, a method for creating an optical circuit includes: integrating a semiconductor slab of a semiconductor material on a substrate, wherein the semiconductor slab includes edges along opposing sides of the semiconductor slab, the semiconductor slab having a first width as measured from one edge to the opposing edge; and integrating a rib waveguide on the semiconductor slab, the rib waveguide having a second width to constrain an optical fundamental mode to be transmitted via a direction of propagation via the rib waveguide, wherein the first and second widths are parallel to each other and orthogonal to the direction of propagation of the fundamental mode; wherein integrating the semiconductor slab further includes creating geometric disruptions in the edges of the semiconductor slab to scatter higher-order optical modes, wherein the first width of the semiconductor slab is less than the third width of the substrate and greater than the second width of the rib waveguide.

In one embodiment, creating the geometric disruptions comprises creating an edge with a serrated edge pattern. In one embodiment, creating the serrated edge pattern comprises creating a serrated edge pattern on both edges of the semiconductor slab, wherein the serrated edge pattern is the same on both edges. In one embodiment, a serration maximum of the serrated edge pattern on one edge is aligned with a serration minimum of the serrated edge pattern on the other edge. In one embodiment, a serration maximum of the serrated edge pattern on one edge is offset relative to a serration minimum of the serrated edge pattern on the other edge. In one embodiment, the serrated edge comprises a sawtooth pattern. In one embodiment, the serrated edge comprises regularly spaced serration features. In one embodiment, the serrated edge comprises serration features having different size and/or spacing with respect to each other. In one embodiment, creating the geometric disruptions comprises creating geometric disruptions along an entire length of the rib waveguide, the length of the rib waveguide being along the direction of propagation of the fundamental mode. In one embodiment, creating the geometric disruptions comprises creating geometric disruptions along only selected portions of an entire length of the rib waveguide, the length of the rib waveguide being along the direction of propagation of the fundamental mode. In one embodiment, creating the geometric disruptions comprises creating geometric disruptions along both edges.

In one aspect, an apparatus for creating an optical circuit includes: means for integrating a semiconductor slab of a semiconductor material on a substrate, wherein the semiconductor slab includes edges along opposing sides of the semiconductor slab, the semiconductor slab having a first width as measured from one edge to the opposing edge; and means for integrating a rib waveguide on the semiconductor slab, the rib waveguide having a second width to constrain an optical fundamental mode to be transmitted via a direction of propagation via the rib waveguide, wherein the first and second widths are parallel to each other and orthogonal to the direction of propagation of the fundamental mode; wherein the means for integrating the semiconductor slab further includes means for creating geometric disruptions in the edges of the semiconductor slab to scatter higher-order optical modes, wherein the first width of the semiconductor slab is less than the third width of the substrate and greater than the second width of the rib waveguide.

In one embodiment, the means for creating the geometric disruptions comprises means for creating an edge with a serrated edge pattern. In one embodiment, the means for creating the serrated edge pattern comprises means for creating a serrated edge pattern on both edges of the semiconductor slab, wherein the serrated edge pattern is the same on both edges. In one embodiment, a serration maximum of the serrated edge pattern on one edge is aligned with a serration minimum of the serrated edge pattern on the other edge. In one embodiment, a serration maximum of the serrated edge pattern on one edge is offset relative to a serration minimum of the serrated edge pattern on the other edge. In one embodiment, the serrated edge comprises a sawtooth pattern. In one embodiment, the serrated edge comprises regularly spaced serration features. In one embodiment, the serrated edge comprises serration features having different size and/or spacing with respect to each other. In one embodiment, the means for creating the geometric disruptions comprises means for creating geometric disruptions along an entire length of the rib waveguide, the length of the rib waveguide being along the direction of propagation of the fundamental mode. In one embodiment, the means for creating the geometric disruptions comprises means for creating geometric disruptions along only selected portions of an entire length of the rib waveguide, the length of the rib waveguide being along the direction of propagation of the fundamental mode. In one embodiment, the means for creating the geometric disruptions comprises means for creating geometric disruptions along both edges.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

1. An optical circuit, comprising:
a rib waveguide including a semiconductor material, the rib waveguide having a first width to constrain an optical fundamental mode to be transmitted in a direction of propagation via the rib waveguide; and
a semiconductor slab of the semiconductor material integrated on a substrate, the rib waveguide being disposed on the semiconductor slab, wherein the semiconductor slab has a second width and includes edges parallel to the direction of propagation of the fundamental mode, wherein the substrate has a third width, wherein the second width of the semiconductor slab as measured from one edge to the other is less than the third width of the substrate and greater than the first width of the rib waveguide, wherein the first, second, and third widths are orthogonal to the direction of propagation of the fundamental mode, and wherein both edges of the semiconductor slab includes geometric disruptions to scatter optical modes in the semiconductor slab other than the fundamental mode;
wherein the geometric disruptions comprise serrated edge patterns, and wherein a serration maximum of the serrated edge pattern on one edge is offset relative to a serration maximum on the serrated edge pattern on the other edge.

2. (canceled)

3. The optical circuit of claim 1, wherein the serrated edge pattern is the same on both edges.

4. The optical circuit of claim 3, wherein a serration maximum of the serrated edge pattern on one edge is aligned with a serration minimum of the serrated edge pattern on the other edge.

5. (canceled)

6. The optical circuit of claim 1, wherein the serrated edge comprises a sawtooth pattern.

7. The optical circuit of claim 1, wherein the serrated edge comprises regularly spaced serration features.

8. The optical circuit of claim 1, wherein the serrated edge comprises serration features having different size and/or spacing with respect to each other.

9. The optical circuit of claim 1, wherein the geometric disruptions are included in the edge of the waveguide slab for an entire length of the rib waveguide, the length of the rib waveguide being along the direction of propagation of the fundamental mode.

10. A system with an optical circuit, comprising:
a processor having an integrated optical circuit, the integrated optical circuit including
a rib waveguide including a semiconductor material, the rib waveguide having a first width to constrain an optical fundamental mode to be transmitted in a direction of propagation via the rib waveguide; and
a semiconductor slab of the semiconductor material integrated on a substrate, the rib waveguide being disposed on the semiconductor slab, wherein the semiconductor slab has a second width and includes edges parallel to the direction of propagation of the fundamental mode, wherein the substrate has a third width, wherein the second width of the semiconductor slab as measured from one edge to the other is less than the third width of the substrate and greater than the first width of the rib waveguide, wherein the first, second, and third widths are orthogonal to the direction of propagation of the fundamental mode, and wherein both edges of the semiconductor slab includes geometric disruptions to scatter higher-order optical modes in the semiconductor slab;
wherein the geometric disruptions comprise serrated edge patterns, and wherein a serration maximum of the serrated edge pattern on one edge is offset relative to a serration maximum on the serrated edge pattern on the other edge; and
a connector to couple with an optical fiber array to transfer inter-chip signals between the integrated optical circuit of the processor and a device off chip to the processor.

11. (canceled)

12. The system of claim 10, wherein the serrated edge pattern on one edge is a mirror image of the serrated edge pattern of the other edge.

13. The system of claim 12, wherein a serration maximum of the serrated edge pattern on one edge is aligned with a serration minimum of the serrated edge pattern on the other edge.

14. (canceled)

15. The system of claim 10, wherein the serrated edge comprises a sawtooth pattern.

16. The system of claim 10, wherein the serrated edge comprises regularly spaced serration features.

17. The system of claim 10, wherein the geometric disruptions are included in the edge of the waveguide slab along only a portion of a length of the rib waveguide, the length of the rib waveguide being along the direction of propagation of the fundamental mode.

18. A method comprising:
integrating a semiconductor slab of a semiconductor material on a substrate, wherein the semiconductor slab includes edges along opposing sides of the semiconductor slab, the semiconductor slab having a first width as measured from one edge to the opposing edge; and
integrating a rib waveguide on the semiconductor slab, the rib waveguide having a second width to constrain an optical fundamental mode to be transmitted via a direction of propagation via the rib waveguide, wherein the first and second widths are parallel to each other and orthogonal to the direction of propagation of the fundamental mode;
wherein integrating the semiconductor slab further includes creating geometric disruptions in the edges of the semiconductor slab to scatter higher-order optical modes, wherein the first width of the semiconductor slab is less than a third width of the substrate and greater than the second width of the rib waveguide;
wherein creating the geometric disruptions comprises creating edges with serrated edge patterns, and wherein a serration maximum of the serrated edge pattern on one edge is offset relative to a serration maximum on the serrated edge pattern on the other edge.

19. (canceled)

20. The method of claim 18, wherein creating the serrated edge pattern comprises creating a serrated edge pattern having regularly spaced serration features.

21. The method of claim 18, wherein creating the geometric disruptions comprises creating geometric disruption features in the edges of the waveguide slab along an entire length of the rib waveguide.

22. The optical circuit of claim 1, wherein a serration width as measured from the serration maximum to the serration minimum on one of the edges comprises a distance at least approximately equal to the first width of the rib waveguide.

23. The optical circuit of claim 22, wherein the distance is at least twice the first width of the rib waveguide.

24. The system of claim 10, wherein a serration width as measured from the serration maximum to the serration minimum on one of the edges comprises a distance at least approximately equal to the first width of the rib waveguide.

25. The system of claim 24, wherein the distance is at least twice the first width of the rib waveguide.

26. The method of claim 18, wherein creating the serrated edge patterns comprises creating a serrated edge pattern on one edge that is a mirror image of the serrated edge pattern of the other edge, wherein a serration maximum of the serrated edge pattern on one edge is aligned with a serration minimum of the serrated edge pattern on the other edge.

27. The method of claim 18, wherein creating the serrated edge patterns comprises creating serrated edge patterns with a serration width as measured from the serration maximum to the serration minimum on one of the edges is a distance at least approximately equal to the second width of the rib waveguide.

28. The method of claim 27, wherein the distance is at least twice the second width of the rib waveguide.
